(19) United States
(12) Patent Application Publication
(10) Pub. No.: US 2011/0035557 A1
(43) Pub. Date: Feb. 10, 2011

(54) FRAGMENTATION REDUCTION USING VIRTUAL SECTORS FOR STATIC DATA

(75) Inventor: Olli Olavi Luukkainen, Salo (FI)

Correspondence Address: Locke Lord Bissell & Liddell;IP Docket Department, 3 World Finanial Center, New York, NY, 10281-2101, US

(73) Assignee: NOKIA CORPORATION, Espoo (FI)

(21) Appl. No.: 12/536,054

(22) Filed: Aug. 5, 2009

(51) Int. Cl. G06F 12/00

(52) U.S. Cl. 711/154; 711/203; 711/E12.001

(57) ABSTRACT

A system for facilitating enhanced storage efficiency. Operational scenarios that include, for example, many distinct files that are smaller than a read/write block size in an apparatus may result in large portions of unused memory. Sectors that would have normally fallen within a block occupied by a small file may be replaced by “virtual” sectors. The virtual sectors may be mapped in an intermediate control level so that small files may still be read using a standard block size without wasting actual physical memory space. The physical sectors that were previously virtualized may then, for example, be used to “extend” the available memory.

### BACKGROUND

1. Field of Invention

The present invention relates to the memory management, and more specifically to more efficient utilization of physical storage via creation of virtual sectors for unused space.

2. Background

Data that is consumed and/or created by electronic apparatuses may be retained in accordance with various memory implementations. Example memories for storing electronic data may be static or dynamic, may be removable from, or fixed within, apparatuses and may comprise electronic, electromechanical, magnetic and/or optical technologies. The particular configuration of memory that is implemented in an apparatus may depend on the operational requirements (or limitations) of the apparatus/system in which the memory is being utilized.

Memories for electronic data storage are typically divided into addressable units in which information may be stored (e.g., sectors). These addressable units are, in many cases, the smallest increment of memory into which data may be stored. Sectors may be grouped (e.g., in blocks) in order to expedite read and/or write activities, because managing a large number of sectors each on an individual basis may not be convenient with metadata structures becoming larger, and thus, requiring more storage space, etc. In particular, faster operation may be attained through accessing and storing the grouped sectors at substantially the same instance. While such group operation may be beneficial overall, program files or data that may be smaller than even a single sector must still occupy an entire block. This occurs because though the data is, in actuality, much smaller in size than an entire block of sectors, data must be read/written a full block at a time. Therefore, these small files/data must occupy an entire block of sectors.

In view of the above limitation, it is foreseeable that large portions of memories could remain unused when the information to be stored comprises many distinct data files that are substantially smaller than the read/write block size. Defragmentation cannot alleviate this problem as the data does not comprise fragmented parts of a larger file, and therefore, despite rearrangement the information will still be bound by the limitation of one file per memory block. As a result, large amounts of this type of file (e.g., individual files/data that are smaller that the smallest read/write unit, such as operating system files) will result in a sizable portion of unused memory space being wasted, which may be detrimental in apparatuses where memory is limited.

### SUMMARY

Various example embodiments of the present invention may be directed to a method, apparatus and computer program product for facilitating enhanced storage efficiency. Operational scenarios that include, for example, many distinct files that are smaller than the standard read/write block size in an apparatus may result in large portions of unused memory. According to various embodiments of the present invention, sectors that would have normally fallen within a block occupied by a small file may be replaced by “virtual” sectors. The virtual sectors may be mapped in an intermediate control level so that small files may still be read using a standard block size without wasting actual physical memory space. The physical sectors that were previously virtualized may then, for example, be used to “extend” the available memory.

In accordance with at least one example implementation, an apparatus may realize a need to access stored information. This may occur, for example, due to activity occurring at the program file (e.g., application) level within the apparatus. Upon identification of at least one read/write block in which the data is to be accessed resides, a determination may be made as to whether each logical sector address in the range of logical sector addresses comprised within the read/write block is a physical sector or a virtual sector. Virtual sectors may be “place holders” for logical sector addresses that are defined for short periods of time when data is being accessed by the intermediate control layer. Virtual sectors do not contain information, and may be used merely so that standard block reads/writes can be performed when accessing small files. For instance, the apparatus may determine that a logical sector address points to a physical sector if the address is higher than the address of the last virtual sector. This determination may be made using a table that maps the various virtual and physical sectors that are defined in the memory.

If a physical sector is identified by the logical address, the location of the physical sector may be resolved and information may be accessed and/or written. Otherwise, one or more alternative activities may occur as orchestrated by, for example, the intermediate control layer. Alternative activities may include such actions as responding with default or “dummy” data, returning no information, or returning a message or error indicating that the sector is virtual.

The foregoing summary includes example embodiments of the present invention that are not intended to be limiting. The above embodiments are used merely to explain selected aspects or steps that may be utilized in implementations of the present invention. However, it is readily apparent that one or more aspects, or steps, pertaining to an example embodiment can be combined with one or more aspects, or steps, of other embodiments to create new embodiments still within the scope of the present invention. Therefore, persons of ordinary skill in the art would appreciate that various embodiments of the present invention may incorporate aspects from other embodiments, or may be implemented in combination with other embodiments.

### DESCRIPTION OF DRAWINGS

The invention will be further understood from the following description of various example embodiments, taken in conjunction with appended drawings, in which:

FIG. 1 discloses an example communication architecture that is usable when implementing the various example embodiments of the present invention.

FIG. 2 discloses the organization of an example of a memory structure usable in accordance with at least one embodiment of the present invention.

FIG. 3 discloses an example memory usage scenario for an example memory structure usable in accordance with at least one embodiment of the present invention.

FIG. 4A discloses an example of virtual sector implementation and the resulting virtualized sectors in accordance with at least one embodiment of the present invention.

FIG. 4B discloses a more detailed example of virtual sector implementation in accordance with at least one embodiment of the present invention.

FIG. 5 discloses an example sector map in accordance with at least one embodiment of the present invention.

FIG. 6 discloses a flowchart for an example data locating and access process in accordance with at least one embodiment of the present invention.

### DESCRIPTION OF EXAMPLE EMBODIMENTS

While the invention has been described below in terms of a multitude of example embodiments, various changes can be made therein without departing from the spirit and scope of the invention, as described in the appended claims.

### I. Example System with Which Embodiments of the Present Invention may be Implemented

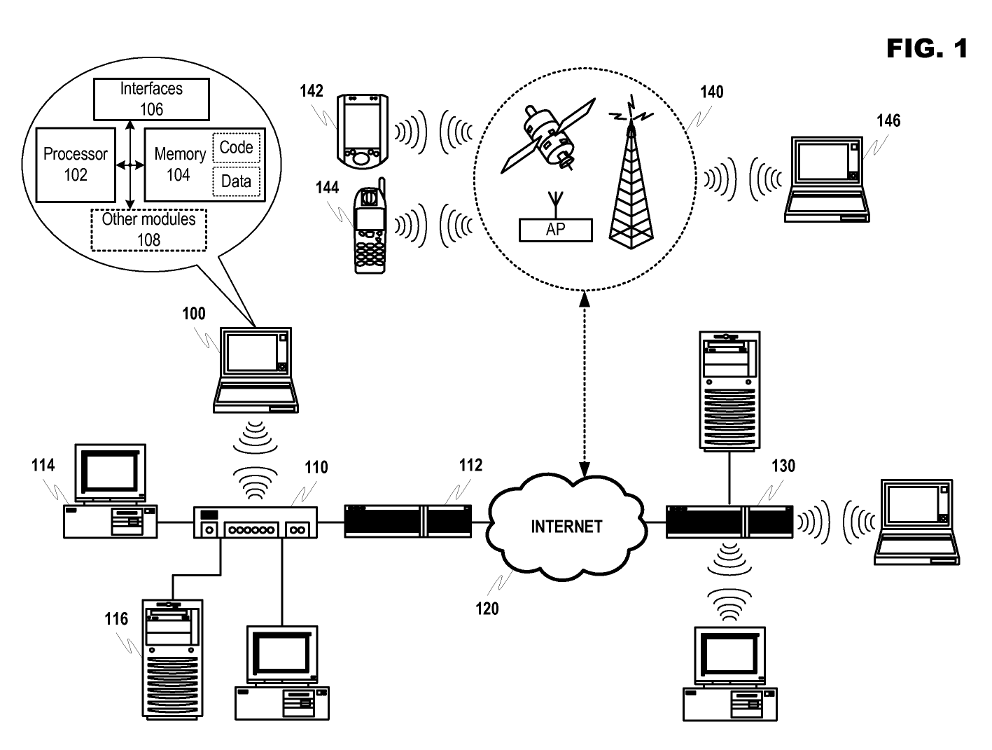

An example of a system that is usable for implementing various embodiments of the present invention is disclosed in FIG. 1. The system comprises elements that may be included in, or omitted from, configurations depending, for example, on the requirements of a particular application, and therefore, is not intended to limit present invention in any manner.

Computing device 100 may be, for example, a laptop computer. Elements that represent basic example components comprising functional elements in computing device 100 are disclosed at 102-108. Processor 102 may include one or more devices configured to execute instructions. In at least one scenario, the execution of program code (e.g., groups of computer-executable instructions stored in a memory) by processor 102 may cause computing device 100 to perform processes including, for example, method steps that may result in data, events or other output activities. Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 110 may provide wired and/or wireless support to devices such as computer 114 and server 116. Hub 110 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

### II. Example Operational Scenario

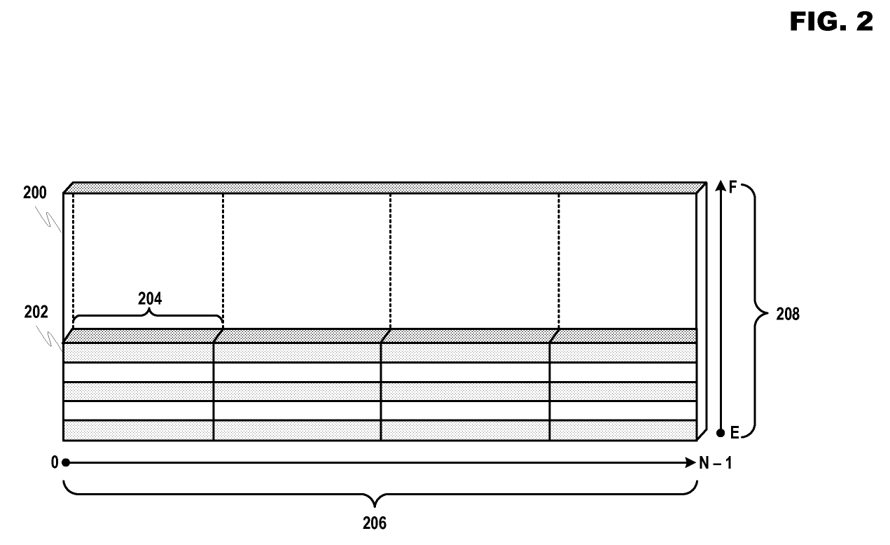

Now referring to FIG. 2, a structural organization of an example memory usable in accordance with at least one embodiment is disclosed. As set forth above, memory 200 may be static (e.g., read-only memory or ROM) or dynamic (e.g., random access memory or RAM). Memory 200 may be removable media from, or fixed within, apparatuses and may be comprised of various technologies such as electronic, electromechanical, magnetic and optical storage technologies. Example implementations of these technologies may include, but are not limited to, Flash memories, electronic programmable read-only memories (EPROM), magnetic hard disks, floppy disks, compact disc read-only memories (CD-ROM), rewritable compact discs (CD/RW), digital video disks (DVD), etc. The ability to employ standalone defragmentation programs on memory 200 is not particularly relevant to the present disclosure as these programs do not address “internal” fragmentation wherein the unused space exists inside an allocated memory block that is larger than the data to be stored. This space is unusable because it is not individually addressable (e.g., it is smaller than the smallest read/write unit, which in this instance is a read/write block). The various embodiments of the present invention are intended to perform a similar type of function to resolve internal fragmentation of storage volumes, and thus, may be implemented regardless of the applicability of separate defragmentation programs.

Memory 200 will be used for the sake of explanation in the following disclosure. However, it is important to note that the various example embodiments of the present invention are not limited to operation on this particular memory structure or solely in the disclosed manner. The principals or strategies disclosed herein may also be applied to other memory configurations.

In the example memory 200 disclosed in FIG. 2, blocks 202 of sectors 204 may be accessed during read and write procedures. Blocks allow multiple sectors to be accessed in a substantially simultaneous manner, which may result in increased speed during read/write operations. While example blocks 202 in FIG. 2 comprise four sectors 204, the present invention is not limited to this configuration. It may be more generally said that each block 202 contains “N” sectors 204, wherein the sectors 204 in block 202 are addressable in range 206 from “0” to “N-1.” Empty space in memory 200 may further be consumed (e.g., filled with information) from bottom to top, which is represented by indicia 208 showing an empty “E” memory 200 being filled from bottom to top, resulting in the memory being full “F” as further shown at 208.

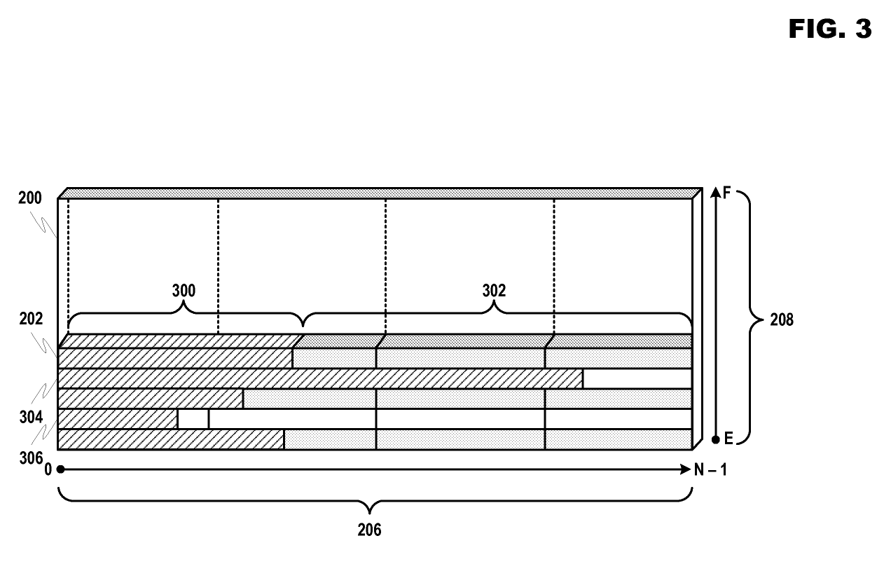

Example operations involving memory 200 are disclosed in FIG. 3. Usage is indicated in FIG. 3 by crosshatching 300, while solid areas 302 indicate unused memory space. In traditional operation, only one file/application can occupy each block 202. It is possible for parts of the same file to occupy multiple blocks 202 in cases where the file size is larger than the block size (in this instance four sectors). However, a file that is smaller than block size 202 cannot share the space with another file. For example, the particular block shown at 304 utilizes most of the available sector space, and little waste is experienced. However, the block indicated at 306 contains very little information (e.g., a small file/data that, in total, is less than one sector). Most of the block at 306 is not used, and thus at least three sectors of memory space is wasted.

FIG. 3, when taken as a whole, discloses an example memory utilization scenario. Memory usage of this manner may occur in situations where there are many small files and/or folders (e.g., in many file systems folders behave similarly to files) to store. For example, a plurality of individual small files and/or folders may pertain to operating system components, communication and other support utilities, user interfaces, small applications (e.g., applets), etc. Memories that must store many small data elements will inevitably experience inefficiency due to the difference in file size vs. minimum read/write block size. In particular, sizable sections of memory, or “fragments” may go unused due to single files of a size much smaller than block 202 occupying entire blocks. This “fragmentation” may initially result in wasted memory space, and may further impact access times since portions of the same application may be stored in blocks 202 that are separated by other blocks 202 that contain various intervening small programs that are occupying entire sectors, which may cause longer search and/or access times for data.

While not extremely efficient, such operation may not create critical problems for systems having large amounts of memory 200 (e.g., servers, desktop/laptop/palmtop computers, etc.). However, apparatuses with memory, processing and/or power limitations may experience substantial negative impacts from this type of behavior. For instance, software in mobile devices is often designed to be compact given the limited amount of storage space. These apparatuses are also often powered by batteries, which means that power-conscious, and therefore simpler, interfaces may be implemented. These measures may result in the software for mobile devices comprising many small individual pieces. These small programs, files, interfaces, etc., while having being more efficient from the standpoint of execution, may actually be inefficient from the standpoint of storage as many sectors may be left unused due to the read/write block size.

### III. Example Implementation of Virtual Memory Elements

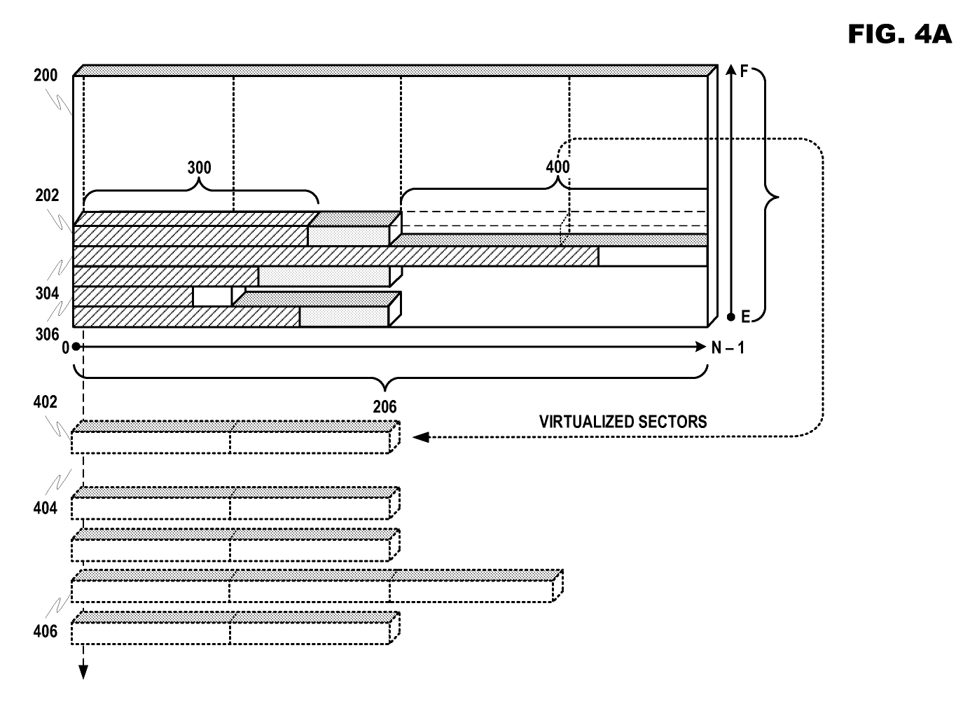

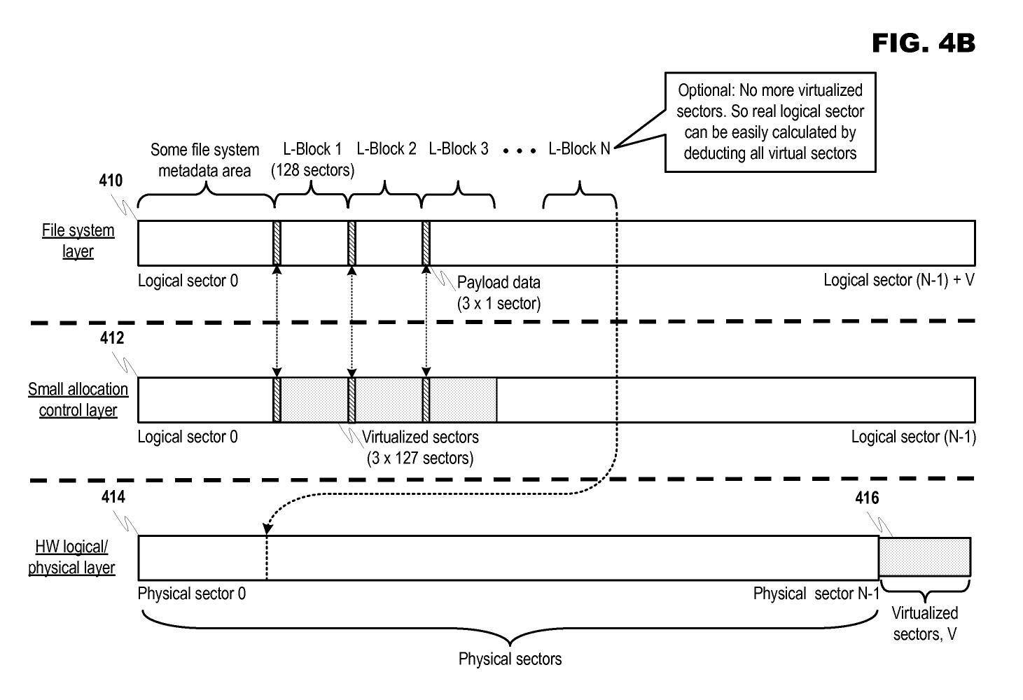

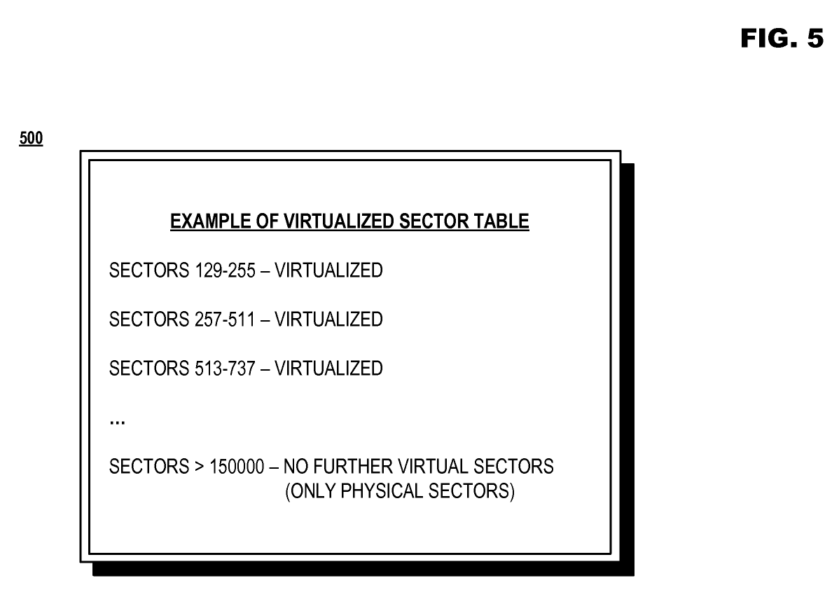

Now referring to FIG. 4A, an example implementation in accordance with at least one embodiment of the present invention is disclosed. The same example scenario that was used above to describe unused fragments of memory due to read/write block size is now used to show that unused sectors may virtualized, and hence utilized. The unused sectors previously identified at 302 may be replaced by “virtual” sectors as shown at 400 in FIG. 4A. Virtual sectors do not actually exist in the sense that they would pertain to a physical sector containing informational content. Instead, virtual sectors 400 are simply a reference recorded, for example, in a sector table, an example of which will be explained further with respect to FIG. 5. References to virtual sectors 400 may be created, for example, at the time when a block containing small file data 300 is read. As a result, small file data 300 may be read using a standard read/write block without wasting actual physical memory. More specifically, virtual sectors 400 act as surrogate sectors during accessing, allowing the unused physical memory to be re-tasked for storing useful data.

Physical sectors that become available after being replaced by virtual sectors, or “virtualized” sectors, are also shown in FIG. 4A. For example, virtualized sectors 400 may be reallocated for storing other information since virtual sectors 400 have taken their place in block 202. On the contrary, there is not a full sector remaining unused in the example block shown at 304, and therefore, there are no resulting virtualized sectors at 404. Since the information stored in the block shown at 306 is smaller than a single sector 204, the remaining three physical sectors 202 in this block may be reallocated. These virtualized sectors are disclosed in FIG. 4A at 406.

FIG. 4B discloses detailed examples of structural and operational characteristics for virtual memory elements in accordance with various embodiments of the present invention. Three layers are depicted in the example of FIG. 4B: a file system (e.g., application) layer 410 and a Hardware (HW) logical/physical layer 414 separated by an intermediate control layer, or small allocation control layer 412 in the disclosed example configuration. HW layer 414 may comprise mass memory having N number of physical sectors in which data may be stored. In ordinary operation, file system/application layer 410 can access at least logical sectors from 0 to N-1. Under normal circumstances HW layer 414 would map each logical sector to a physical sector. However, various embodiments of the present invention alter this process so that access requests using standard read/write blocks can be mapped to both physical and virtual sectors.

In at least one example implementation, intermediate layer 412 may be inserted between file system/application layer 410 and HW layer 414. In FIG. 4B intermediate layer 412 corresponds to small allocation control layer 412, which may be configured to control small static allocations of memory. As these small allocations are static, they may be predefined based on small files and folders existing, for example, as part of the original drive image (e.g., as part of an apparatus operating system). For example, small allocation control layer 412 may create virtual sectors to take the place of each physical sector that will be accessed by read/write blocks (e.g., L-block1 to L-blockN) but will not be utilized to store data for the small files or folders.

In at least one example implementation, entities (e.g., applications) in file system layer 410 that attempt to access data residing in HW layer 414 will first access intermediate layer 412. In the example of FIG. 4B this intermediate layer 412 is the small allocation control layer, which will determine which of the sectors addressed in the read/write block are physical and which of the sectors are virtual. Small allocation control layer 412 may then return the content stored in each physical sector being addressed by the read/write block to file system layer 410, while performing an alternative activity for each virtual sector being addressed in the block. In particular, small allocation control layer 412 may not provide actual content information from the virtual sectors as these addresses only exist as placeholders, and thus, have not actual content. Alternative activities may therefore include, for example, providing default (e.g., “dummy” or filler) information to file system layer 410, providing no information to file system layer 410, providing a message or code (e.g., an error) to file system layer 410, etc.

Blocks 202 in file system layer 410 that are not, to a large extent, filled (e.g., due to small file being stored in sectors 202) may be virtualized and reallocated, while the remaining sectors 202 may continue to operate in the manner of traditional physical sectors. The resulting total size of memory 200 may then be extended to N(physical sectors)+V(number of virtualized sectors). Optionally, addresses for sectors 202 may be calculated by deducting the addresses of virtual sectors from the total range of addresses, leaving only physical sectors remaining.

When a file system image may contain predefined files and folders, small static allocations may be detected and recorded as a configuration information when the image is first created in physical memory 200. Physical sectors 204 that are utilized in storing data for blocks of files/folders may be allocated normally, but physical sectors 204 that don't contain any data may be virtualized. Virtual sectors 416 may then make up the remainder sectors of the block(s).

In accordance with at least one embodiment of the present invention, an example of a virtualized sector table is shown at 500. Virtualized sector table 500 may comprise address information corresponding to both physical sectors being utilized to store information and virtual sectors taking the place of unused physical sectors. The address information may be utilized when determining what content, dummy content, error, etc. to return when a read block request includes a particular sector address. For example, when partitions made up of virtualized sectors are accessed, small allocation control layer 212 virtualizes the sectors which currently do not contain data. Virtualization may, for example, cause the sector number of the physical sector 204 which is not being used to store data (e.g., in the case of small files) to be adjusted so that it is skipped. As set forth above, the access request cannot never read or write virtualized sectors. Read operations could however return dummy data and write operations may just be skipped.

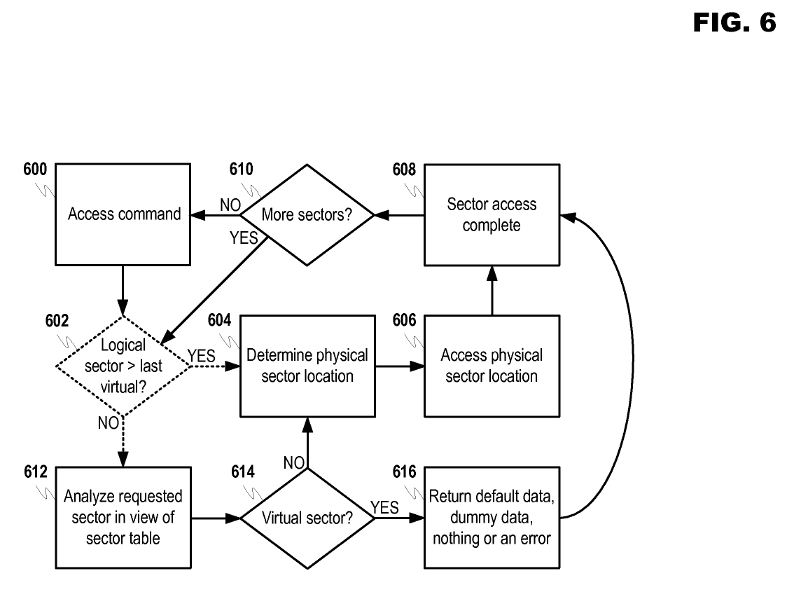

Now referring to FIG. 6, a flowchart of an example access process in accordance with at least one embodiment of the present invention is disclosed. In step 600 a logical sector access command is realized in an apparatus. This access command may, for example, comprise a request to access information in one or more read/write blocks that each contain a range of sector addresses. The process may then proceed to optional step 602 where a determination may be made as to whether the current logical sector address being requested is greater than the last virtual sector address. If the current logical sector address is greater than the last virtual sector address, an assumption may be made that the current logical address must refer to a physical sector. While the determination made in step 602 is not essential to the various embodiments of the present invention disclosed herein, including such a process step may increase the speed of virtual/physical sector checking, and thus, may increase overall process speed. The location of the physical sector may be resolved in step 604, which may be followed by accessing the physical sector (e.g., reading information from, or writing information to, the sector) in step 606.

The process may then proceed to step 608 where accessing the current logical sector in the range of logical sectors within the one or more blocks to be accessed is completed. A determination may then be made in step 610 as to whether logical sectors remain in the range of sectors in the one or more blocks to be accessed. If logical sectors remain, the process may return to step 602 to determine if the current logical sector address is greater than the last virtual sector address. Otherwise, the process may return to step 600 to await the next access command.

If in step 602 the current logical sector address is determined to be less than the last virtual sector address, then in step 612 the current logical sector address may be analyzed in view of a sector table. This analysis may comprise, for example, comparing the current logical sector address to addresses listed in the sector table in order to determine whether the current logical address refers to a physical sector or a virtual sector. If the current logical sector address refers to a physical sector (e.g., the sector is not virtual as determined in step 614), the process then returns to step 604 to determine a location for the physical sector. Otherwise, the process proceeds to step 616 wherein an alternative activity is performed. Alternate activities may comprise, for example, returning default or dummy information, returning no information and/or returning a message (e.g., an error). The process then returns to step 608 wherein sector access is determined to be complete. The process may then reinitiate for the next sector if more sectors are determined to exist in step 610, or may return to step 600 to await the next access command.

The various embodiments of the present invention are not limited only to the examples disclosed above, and may encompass other configurations or implementations.

For example, example embodiments of the present invention may encompass apparatuses comprising means for identifying a requirement for accessing at least one read/write block in a memory, wherein the read/write block is identified by a range of logical sector addresses, means for determining whether each logical sector address in the range of logical sector addresses corresponds to a physical sector or a virtual sector, means for, if the address corresponds to a physical sector, determining the location of the physical sector and accessing the physical sector, and means for, if the address corresponds to a virtual sector, performing an alternative activity as defined by an intermediate control layer.

At least one other example embodiment of the present invention may include electronic signals that cause apparatuses to identify a requirement for accessing at least one read/write block in a memory, wherein the read/write block is identified by a range of logical sector addresses, determine whether each logical sector address in the range of logical sector addresses corresponds to a physical sector or a virtual sector, if the address corresponds to a physical sector, determining the location of the physical sector and access the physical sector, and if the address corresponds to a virtual sector, performing an alternative activity as defined by an intermediate control layer.

Accordingly, it will be apparent to persons skilled in the relevant art that various changes in form a and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising:
identifying a requirement for accessing at least one read/write block in a memory, wherein the read/write block is identified by a range of logical sector addresses;
determining whether each logical sector address in the range of logical sector addresses corresponds to a physical sector or a virtual sector;
if the address corresponds to a physical sector, determining the location of the physical sector and accessing the physical sector; and
if the address corresponds to a virtual sector, performing an alternative activity as defined by an intermediate control layer.

2. The method of claim 1, wherein the virtual sector is defined at the time the requirement for accessing the at least one read/write block is identified.

3. The method of claim 1, wherein each virtual sector corresponds to an unused sector in a previously stored read/write block.

4. The method of claim 1, wherein determining whether each logical sector address in the range of logical sector addresses corresponds to a physical sector or a virtual sector comprises comparing the logical sector address to mapping in a sector table.

5. The method of claim 4, wherein the sector table is maintained by the intermediate control layer.

6. The method of claim 1, wherein the alternative activity comprises at least one of a returning a dummy value, no value or an error in response to access requirement.

7. A computer program product comprising computer executable program code recorded on a computer readable storage medium, the computer executable program code comprising:
code configured to identify a requirement for accessing at least one read/write block in a memory, wherein the read/write block is identified by a range of logical sector addresses;
code configured to determine whether each logical sector address in the range of logical sector addresses corresponds to a physical sector or a virtual sector;
code configured to, if the address corresponds to a physical sector, determine the location of the physical sector and access the physical sector; and
code configured to, if the address corresponds to a virtual sector, perform an alternative activity as defined by an intermediate control layer.

8. The computer program product of claim 7, wherein the virtual sector is defined at the time the requirement for accessing the at least one read/write block is identified.

9. The computer program product of claim 7, wherein each virtual sector corresponds to an unused sector in a previously stored read/write block.

10. The computer program product of claim 7, wherein determining whether each logical sector address in the range of logical sector addresses corresponds to a physical sector or a virtual sector comprises comparing the logical sector address to mapping in a sector table.

11. The computer program product of claim 10, wherein the sector table is maintained by the intermediate control layer.

12. The computer program product of claim 7, wherein the alternative activity comprises at least one of a returning a dummy value, no value or an error in response to access requirement.

13. An apparatus, comprising:
at least one processor; and
at least one memory including executable instructions, the at least one memory and the executable instructions being configured to, in cooperation with the at least one processor, cause the device to perform at least the following:
identify a requirement for accessing at least one read/write block in a memory, wherein the read/write block is identified by a range of logical sector addresses;
determine whether each logical sector address in the range of logical sector addresses corresponds to a physical sector or a virtual sector;
if the address corresponds to a physical sector, determine the location of the physical sector and access the physical sector; and
if the address corresponds to a virtual sector, perform an alternative activity as defined by an intermediate control layer.

14. The apparatus of claim 13, wherein the virtual sector is defined at the time the requirement for accessing the at least one read/write block is identified.

15. The apparatus of claim 13, wherein each virtual sector corresponds to an unused sector in a previously stored read/write block.

16. The apparatus of claim 13, wherein determining whether each logical sector address in the range of logical sector addresses corresponds to a physical sector or a virtual sector comprises comparing the logical sector address to mapping in a sector table.

17. The apparatus of claim 16, wherein the sector table is maintained by the intermediate control layer.

18. The apparatus of claim 13, wherein the alternative activity comprises at least one of a returning a dummy value, no value or an error in response to access requirement.

19. A system, comprising:
an application layer;
a physical memory layer; and
an intermediate control layer;
the application layer identifying a requirement for accessing at least one read/write block, wherein the read/write block is identified by a range of logical sector addresses;
the intermediate control layer determining whether each logical sector address in the range of logical sector addresses corresponds to a physical sector or a virtual sector;
if the address corresponds to a physical sector, the physical memory layer determining the location of the physical sector and accessing the physical sector; and
if the address corresponds to a virtual sector, the intermediate control layer performing an alternative activity.
